(19) United States
(12) Patent Application Publication
(10) Pub. No.: US 2021/0222376 A1
(43) Pub. Date: Jul. 22, 2021

(54) ROLL UP ARTIFICIAL TURF

(71) Applicant: Reed J. SEATON, Austin, TX (US)

(72) Inventor: Reed J. SEATON, Austin, TX (US)

(21) Appl. No.: 17/150,953

(22) Filed: Jan. 15, 2021

Related U.S. Application Data
(60) Provisional application No. 62/963,027, filed on Jan. 18, 2020.

(51) Int. Cl. E01C 13/08

(52) U.S. Cl. CPC E01C 13/08

(57) ABSTRACT

A method of creating an artificial turf includes unrolling a plurality of already filled artificial turf sections on a foundation in a desired configuration to cover the foundation and define an athletic field. Each section includes a backing, fibers secured to the backing and extending upwardly therefrom, and a particulate fill surrounding the fibers to a desired depth. The fibers having a construction and density that substantially contains the particulate fill to the backing during the unrolling. Sections along the adjoining seams are then removably connected and particular fill is added along the removably connected seams to create a substantially uniform fill depth for the field.

### FIELD OF THE INVENTION

This invention relates to artificial turf used for athletic fields. More specifically, this invention relates to a filled artificial turf with enhanced versatility, due to its roll up, unroll capability.

### BACKGROUND OF THE INVENTION

In recent years, filled artificial turfs have substantially increased in popularity and use, compared to prior Astroturf-type artificial surfaces and natural grass athletic surfaces. Filled artificial surfaces look and feel more like natural grass, compared to prior Astroturf-type products. Also, compared to a natural grass field, a filled artificial turf has significantly lower maintenance costs, while allowing significantly more playing time.

For certain sporting facilities or venues, particularly indoor arenas or stadia, the facility may be used for a wide variety of events, including non-sporting events. Some of these events could have adverse effects on a typical filled artificial turf, due to excessive wear. These adverse effects become more acute as the number of these events increases. These adverse effects tend to reduce the playability of, and shorten the effective life of the artificial turf. Yet, these facilities need to accommodate non-sporting events to optimize the use and revenue generated by the facility. Thus, there is a need to accommodate the multi-purpose needs of such facilities, while at the same time minimizing or eliminating any adverse effects on the artificial turf used for sporting events.

U.S. patent application Ser. No. 10/104,030, published as U.S. Publication No. US 2002/0136846, in the name of Prevost, shows a Velcro-type, i.e. hook and loop, fastener arrangement for simplified installation of an artificial turf. The fastener arrangement extends along the bottoms of the edges of the field sections. This published U.S. application also shows removable turf sections located in various parts of the field, so that team logos or other insignia may be incorporated into the field. As the initial steps for creating a replaceable logo section, this publication discloses the removal of the infill from the designated logo, followed by cutting of the artificial turf around the perimeter of the logo section.

This publication does not address the need for a sporting facility to accommodate a wide variety of sporting and non-sporting events. Nor does this publication disclose the removal or reinstallation of an entire artificial turf surface as a way to meet that need.

U.S. Pat. App. Publication No. 2004/0058096 A1, entitled “Modular Synthetic Grass Turf Assembly,” discloses a plurality of tray-like artificial field units which are transportable. Each of the field units is, in effect, a mini filled artificial turf. The publication discloses disengageable edge borders on the turf units to help retain the particulate fill during transport. This publication discloses transportation of the units via a forklift, wherein the units remain in horizontal position and are supported on a flat sheet, so as not to deform during shipment or storage. This publication discloses that the tray like turf units have maximum dimensions of 15 feet by 48 feet. Thus, it would necessarily follow that about 80 of such turf units would be needed to cover just the actual playing surface of a typical U.S. football field, which has dimensions of 360 feet by 160 feet. Thus, removing and installing a field of this type would involve significant labor, time and equipment usage.

It is an object of this invention to improve upon the ability of a large facility to readily accommodate both sporting and non-sporting events, without adversely affecting the performance or durability of an artificial turf used in the same facility for sporting events.

It is another object of this invention to simplify and reduce the costs of transforming an indoor stadium from an athletic field, to a non-athletic surface use, and then back to an athletic field.

It is still another object of this invention to reduce the hardware, costs and steps needed to remove and then later reinstall a filled artificial turf.

### SUMMARY OF THE INVENTION

The present invention achieves these above-stated objects via a filled artificial turf field which may be removed by disconnecting and rolling up a plurality of filled artificial turf sections, and reinstalled by unrolling and reconnecting the filled artificial turf sections. The filled artificial turf sections are readily disconnected and reconnected by hook and loop-type fasteners located along the bottoms of the edge joints at the seams located between the adjacently located sections of filled artificial turf. The artificial turf sections are constructed with tufted twisted fibers which substantially contain a particulate infill material, during use and during rolling and unrolling. The fibers have sufficient face weight to entrap or hold substantially all of the particulate infill against the backing. Face weight depends on a combination of parameters, including the fiber's composition, the number of fibers, the height of the fibers, the number of tufts per inch in each row of tufts and the spacing of the tufted rows, i.e. the tuft gauge. As is known in the industry, face weight is the weight of fiber per square yard of unfilled artificial turf. One artificial turf which has proved suitable for this invention is known in the industry as REALGRASS™, made by Sportfield, with a face weight of 44 ounces. Due primarily to the relatively high face weight of this product, only minimal particulate loss occurs during roll up and removal and roll out and reinstallation of these filled artificial turf sections.

The rolls of filled artificial turf sections may be stored at an easily accessible location, preferably within the facility itself. Transport of these rolls to and from the field location may be performed by a vehicle adapted to accommodate rolls of field sections of substantial weight, and with typical dimensions of 15 feet by 160 feet.

With this invention, a large facility can be easily transformed from an athletic venue having an artificial turf to a different use, such as a trade show requiring a concrete floor, and then back, without adversely affecting the filled artificial turf. Also, due largely to the simple hook and loop connections along the seams, and the retention of the particulate fill to the backing, this removal and reinstallation process is relatively simple and cost-effective. It can be done in relatively few steps, in a short time, with almost no additional hardware needed.

According to a preferred embodiment of the invention, each of the filled artificial turf sections includes a horizontal backing of polyethylene fibers tufted to the backing to extend upwardly therefrom, and a resilient particulate fill surrounding the fibers and having a desired height relative to the height of the fibers.

The particulate fill may include one or more component materials, one or more of which may be synthetic materials and one or more of which may be natural materials, including one or more vegetable-based materials. In some embodiments, the particulate fill includes a combination of one or more synthetic materials and one or more naturally occurring materials. Synthetic and naturally occurring materials suitable for use within the particulate fill may include one or more synthetic or naturally occurring hard granular materials combined with one or more synthetic or naturally occurring resilient materials. Suitable synthetic and naturally occurring hard granular materials may include, without limitation, silica or another hard sand, granulated plastics, granulated coal slag, graded small rocks, crushed flint, crushed granite, fly ash, kaolin, alumina, mica, various silicates, talc, boron, and combinations thereof. Suitable synthetic or naturally occurring resilient materials may include without limitation, cork, ground shells or fibers of almonds, coconuts, and walnuts, natural or synthetic polymer beads including, as examples, beads of vinyl chloride, vinyl ether, vinyl acetate, acrylate, methacrylate, and the like, synthetic polymer foam, styrene, neoprene, vermiculite, perlite, and natural and/or synthetic rubber particles, including rubber particles recycled from scrap tires, sometimes referred to as crumb rubber, and particles of ethylene propylene diene monomer (EPDM) rubber. Applicant notes that identifying specific exemplary materials suitable for the particulate fill is not intended as a limitation on the composition of the particulate fill and those of skill in the field will appreciate and recognize that subject matter disclosed herein encompasses equivalent and/or alternative materials for and compositions of particulate fill.

During initial installation, a team of installers unrolls a plurality of sections of artificial turf in a desired configuration on top of a foundation, to form an athletic field. The installers connect adjacently located sections with underlying strips which reside along and below the seams between the adjacently located sections. In some embodiments, the installers pull up the edges of the two adjoining sections, locate the strip under the seam, and then use an adhesive to adhere the top surface of the strip to the bottom surfaces of the adjacently located sections along the edges. Additionally, each of the strips may have, on a lower surface, or underside thereof, a first component of a hook and loop fastener. When the sections are in place, connected together via the underlying adhered strip, the downwardly directed first components reside in direct contact with the underlying surface, in most cases the foundation. During the initial field installation these first components are not used for any fastening purpose.

Thereafter, the installers place a particulate fill on the connected sections, typically by a commercial spreader. The installers spread the particulate fill to create a substantially uniform depth, typically with brooms, to facilitate settling of the particulate fill within and around the upright fibers. These spreading, or top dressing, and brooming steps may be repeated until a desired uniform fill depth is achieved. The field is then ready to be used.

When the facility must be transformed to accommodate a non-sporting event, the field can be removed and stored, section by section. To do this, a team of laborers removes the particulate fill along the seams of the adjacently located sections. This removal may occur by hand or vacuum. This step helps the crew find and get access to the underlying adhered strips, in order to cut the strips along the seams. This cutting step separates the field sections, so that they are now back to their original sizes. However, the field sections are now filled with the particulate fill and they have downwardly directed first connectors extending along the bottoms of the edges. The crew then rolls up the filled field sections, one by one, and moves them to a storage site. Due to the entrapment of the particulate fill by the fibers, the particulate fill particles remain substantially contained during the roll up step. In rolling up the sections, the crew typically uses a rigid, elongated tube. This helps with subsequent transport of the rolled up, filled field sections.

When it is time to reinstall the athletic field, the crew moves the rolled up, filled field sections back to the foundation, to their desired positions. The crew then unrolls the filled filed sections into place, thereby locating the downwardly directed first connectors in direct contact with the underlying surface. Thus, these first connectors and the adhered strips are now part of the filled field sections. Subsequently, for each seam, the crew uses a second underlying strip to removably secure the adjacently located sections. This second strip extends along the seam under the edges of the adjacently located sections. This second strip has a second component of a hook and loop fastener extending from an upper surface thereof.

More specifically, along the seam the adjacently located sections are pulled up to enable the second strip to be located along and below the seam. This places the upwardly directed second component directly below the edges of the adjacently located sections and the corresponding downwardly directed first components. When the edges of the adjacently located sections are then laid back flat, the first and second components of the fastener securely engage each other to removably connect the sections along the seam. The crew then refills particulate above the seams as needed, to create a playing field with a substantially uniform fill depth, at the desired fill height. Thereafter, removal and reinstallation may occur, as needed, by repeating these same steps.

If desired, a pad may be installed over the foundation, where the athletic field will be located, prior to unrolling the sections of artificial turf. The pad, preferably of uniformly thick material, provides an additional degree of resiliency for the artificial turf.

Also, the backing may be perforated, if desired. The perforations enhance water drainage, if the field is to be outdoors. Even if the facility is an indoor stadium or arena, perforations may be desired. Although such perforations will not be used when the artificial turf is used indoors, the in-place perforations allow the artificial turf field to be later reinstalled and used at an outdoor facility, as an outdoor field. So the perforations provide built-in versatility for the artificial turf.

The objects and features of the present invention will become more readily apparent from the following detailed description and the accompanying drawings.

### BRIEF DESCRIPTION OF THE DRAWINGS

FIG. 1 is a perspective view which shows one aspect of initially connecting adjacently located sections of artificial turf, in accordance with a preferred embodiment of the invention.

FIG. 2 is a cross-sectional view taken along lines 2-2 of FIG. 1.

FIG. 3 is a perspective view, similar to FIG. 1, which shows one aspect of removing adjacently located sections, in accordance with a preferred embodiment of the invention.

FIG. 4 is a perspective view, similar to FIGS. 1 and 3 which shows another aspect of removing adjacently located sections of filled artificial turf, in accordance with a preferred embodiment of the invention.

FIG. 5 is a perspective view, similar to FIGS. 1, 3, and 4, which shows one aspect of reinstalling adjacently located sections of filled artificial turf, in accordance with a preferred embodiment of the invention.

FIG. 6 is a perspective view, similar to FIGS. 1, 3, 4, and 5, which shows one aspect of reinstalling adjacently located sections of filled artificial turf, in accordance with a preferred embodiment of the invention.

FIG. 7 is a cross-sectional view taken along lines 7-7 of FIG. 6.

FIG. 8 is a perspective view which shows the installation of a field in accordance with the invention.

### DETAILED DESCRIPTION

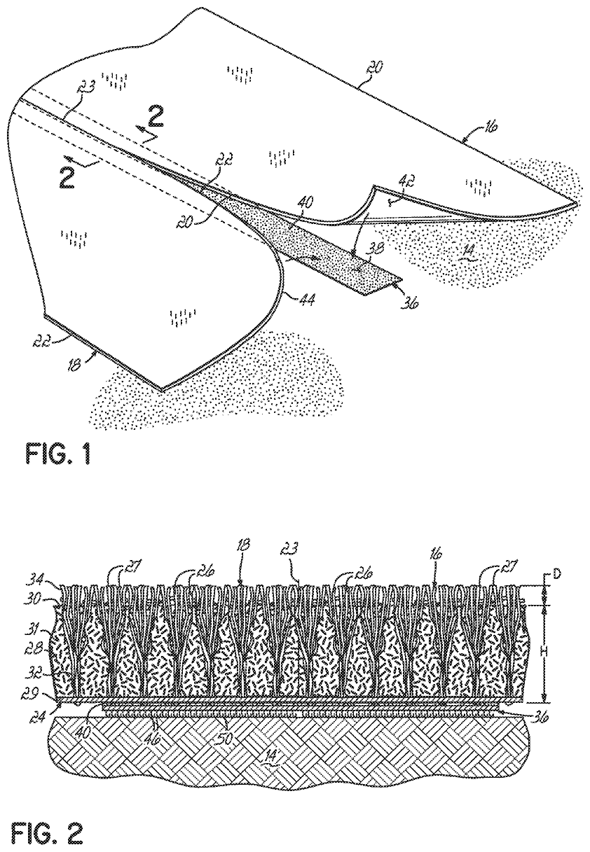

FIG. 1 shows a rectangularly shaped first turf section 16, comprising a first section of artificial turf, residing next to a rectangularly shaped second turf section 18, comprising a second section of artificial turf, on a foundation 14. The shape of the turf sections may vary, depending on the field or the sport. Although the term “artificial turf” is used herein, the term “synthetic surf” is equally suitable. The first turf section 16 has two opposed side edges 20, and similarly, the second turf section 18 has two opposed side edges 22. The first and second turf sections 16, 18 are located next to each other such that one of the side edges 20 of the first turf section 16 abuts one of the side edges 22 of the second turf section 18 along a seam 23. To get a straight seam 23, one or more of the turf sections 16, 18 may be cut after placement on the foundation 14, as is known in the industry.

After placement on the foundation 14, turf sections 16, 18 are pulled up along the seam 23 to place a first connecting strip 36 under the adjacently located first and second turf sections 16, 18 under the seam 23. The connecting strip 36 has an upper surface 38. Adhesive 40 applied to the upper surface 38 adheres the connecting strip 36 to the undersides 42, 44 of the first and second turf sections 16, 18 along the seam 23, as is known in the industry.

FIG. 2 shows that connecting strip 36 has a first component 46 of a two component fastener, namely a hook and loop fastener directed downwardly from a lower surface 50 thereof. The lower surface 50 of the connecting strip 36, and more particularly the first component 46 directly contacts the surface residing below, in this case the foundation 14. Alternatively, a pad could reside below surface 50 (or reference numeral 14 could be regarded as a pad located on top of a foundation). The connecting strip 36 may be nylon, with the first component 46 secured to the lower surface 50 by sewing or adhesive or any other securement structure which secures these components together so as to not pull apart.

After the adjacent first and second turf sections 16, 18 are connected along seam 23 and all of the turf sections of the field are similarly connected, particulate fill 28 is added to create a substantially uniform fill depth as shown in FIG. 2. This is typically done by top dressing with a spreader and then brooming and repeating as necessary, to achieve the desired fill depth. The brooming causes the particulate fill to move or settle downwardly, to surround and support upwardly directed fibers 26. The field 10 is now ready for use.

As shown in FIG. 2, the relationship between the particulate fill 28 and the fibers 26, which extend upwardly from a backing 24, is such that the particulate fill 28 is entrapped or contained during use of the field and thereafter during roll up. In at least one embodiment, the backing 24 has three primaries, the first primary being a woven polypropylene, the second primary being a Colbond or equivalent nonwoven, and the third primary being a woven lenoweave, known in the art as Actionback. A secondary of polyurethane may be coated in liquid form onto the primaries of the backing 24, after the fibers 26 have been tufted. This tufting through two or more primaries is shown in U.S. Pat. No. 5,962,101, which is fully incorporated by reference herein in its entirety. In at least one embodiment, the triple primary backing weighs 10.74 ounces per square yard and the secondary weighs 28 ounces per square yard. The backing has sufficient lateral structural integrity to withstand the rolling and unrolling of repeated installations.

The plurality of grass-like pile filaments, or fibers 26 may be texturized prior to being tufted to the backing 24, to an extent that their overall height is reduced from a selected height of 2.25 inches to a final height of about 1.75 inches. This texturizing causes the fibers 26 to be kinked along their entire length. The fibers 26 may be comprised of monofilament mini tapes with six strands twisted together and one twist per inch. The strands may have a width of about 2 millimeters and a thickness of about 100 microns. The fibers 26 may be made of polyethylene. The yarn denier may be 6/7500 Dtex or alternatively 6/8100 Dtex. The grass-like fibers 26 illustrated in FIG. 2 may be tufted to the backing 24 using a tufting gauge of 0.5 inches, and 6-7 tufts per inch. In some embodiments, the pile weight is 44 ounces per square yard, the weight of the triple primary backing is 10.74 ounces per square yard, the weight of the secondary is 28 ounces per square yard. The upper ends 27 of the fibers 26 may curl down to cover and trap or contain the particulate fill 28, thereby preventing the particulate fill 28 from spilling out during the rolling/unrolling process.

As illustrated in FIG. 2, the particulate fill 28 extends upwardly from the backing 24 to a desired height H. The particulate fill 28 of FIG. 2 has a top level designated by the reference numeral 30 and located a distance “D” below the upper ends 27 of the fibers 26. Thus, the fibers 26 have lower portions 32 located within the particulate fill 28 and upper portions 34 extending above the particulate fill 28. The upper portions 34 give the playing surface a green appearance resembling natural grass. The particulate fill 28 helps stabilize the fibers 26 in place and helps prevent the fibers 26 from becoming trampled or run-down. With a fiber height of 1.75 inches, a suitable height for the particulate fill 28 is 1.375 inches, so that the distance D is 0.375 inches.

As noted previously, the particulate fill 28 may any of one or more suitable materials including one or more suitable synthetic materials, one or more suitable natural materials, or a combination of one or more synthetic materials and one or more natural materials. If desired, the particulate fill 28 may include two distinct layers as disclosed in U.S. patent application Ser. No. 10/634,217, published as U.S. Pat. App. Pub. No. 2004/0028841 A1, which is fully incorporated by reference herein. In one embodiment, the total weight of the filled turf is 78.74 ounces per square yard.

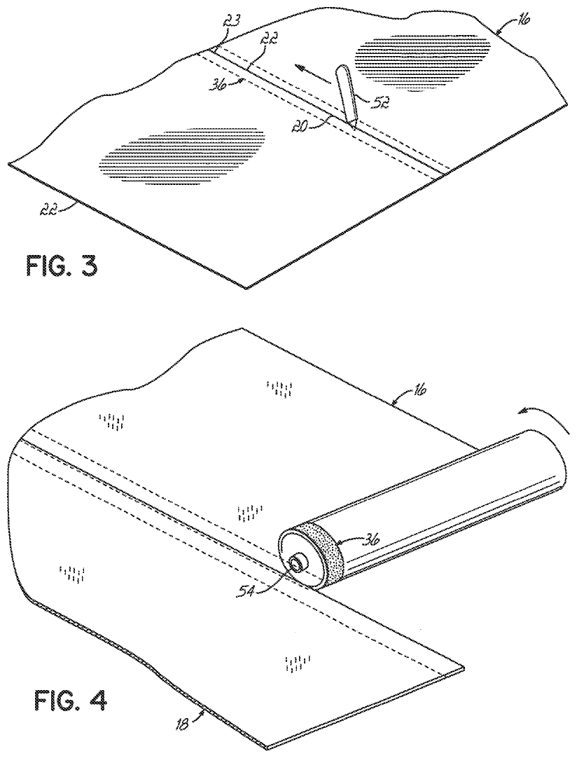

After the field has been used and is ready for removal, particulate fill 28 is removed along the seam 23 of interconnected sections 16, 18. As shown in FIG. 3, the connecting strip 36 is cut along the seam 23 to separate the first and second turf sections 16, 18 with a cutting instrument 52.

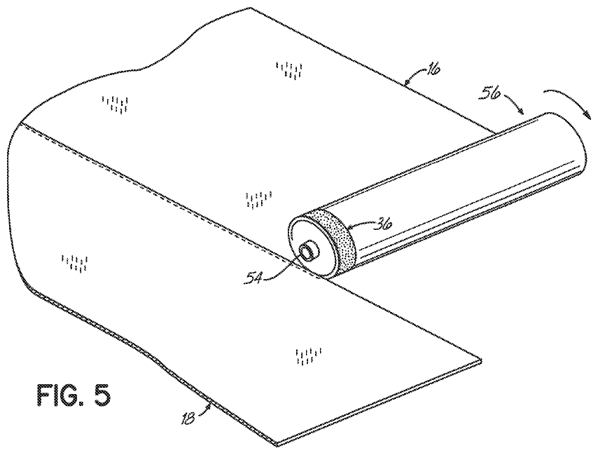

As shown in FIG. 4 after the connecting strip 36 has been cut, thereby separating the first and second turf sections 16, 18, the first turf section 16 is rolled up around a core 54, preferably an elongated hollow tube. If desired, the core 54 may be omitted and the section 16 of filled artificial turf may be rolled up around itself. As the first section of filled artificial turf 16 is being rolled up, a portion of the connecting strip 36 adhered thereto is rolled up as well. Each turf section 16, 18 is rolled up in this manner, and then moved to a storage site or location. This rolling process may be performed manually or be automatically.

Referring to FIG. 5, when it is time to reinstall the field 10, the rolls 56 of sections of filled artificial turf are moved to their desired locations. The first and second turf sections 16, 18 are unrolled and adjusted so one of the side edges 20 of the first turf section 16 abuts one of the side edges 22 of the second turf section 18 along seam 23. Once the turf sections 16, 18 are unrolled and adjusted to their intended positions, the portions of the connecting strip 36 adhered to the sections 16, 18 having the first component 46 of the hook and loop fastener 48 on the underside thereof contact the foundation 14.

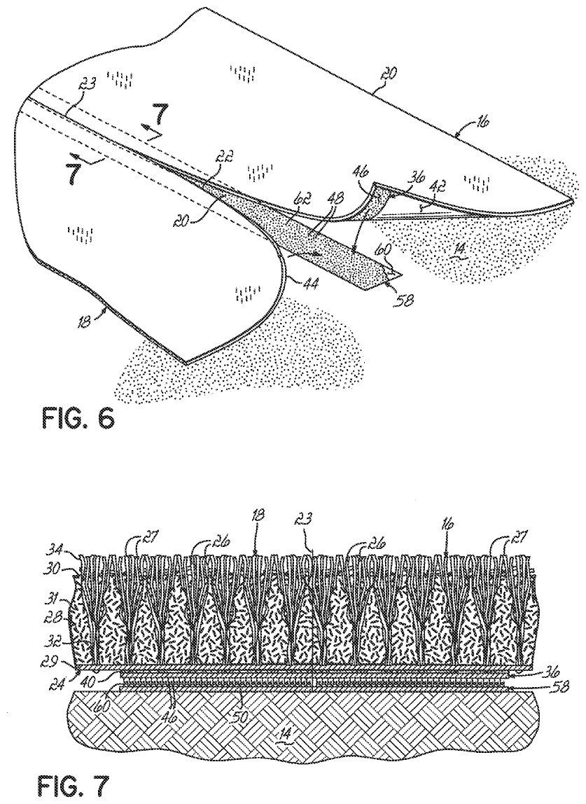

As shown in FIGS. 6 and 7, the longitudinal side edges of the first and second turf sections 16, 18 adjacent to or proximate the seam 23 are pulled upwardly to expose the foundation 14. A second connecting strip 58 is then placed on the foundation 14 under the seam 23 between the first and second turf sections 16, 18 of filled artificial turf. The second connecting strip 58 has located on an upper surface 60 thereof a second component 62 of the hook and loop fastener 48. After the strip 58 is placed in its desired location, the first and second turf sections 16, 18 of filled artificial turf are lowered in the direction of arrows 64 so that the first and second components 46, 62 of the hook and loop fastener 48 removably engage each other, as is known in the art. In this manner, the first and second turf sections 16, 18 are removably joined together. Thereafter, particulate fill 28 is placed over the seam 23 to create a uniform field depth. Any number of sections or segments of filled artificial turf may be easily joined together in this manner to create a removable athletic playing surface.

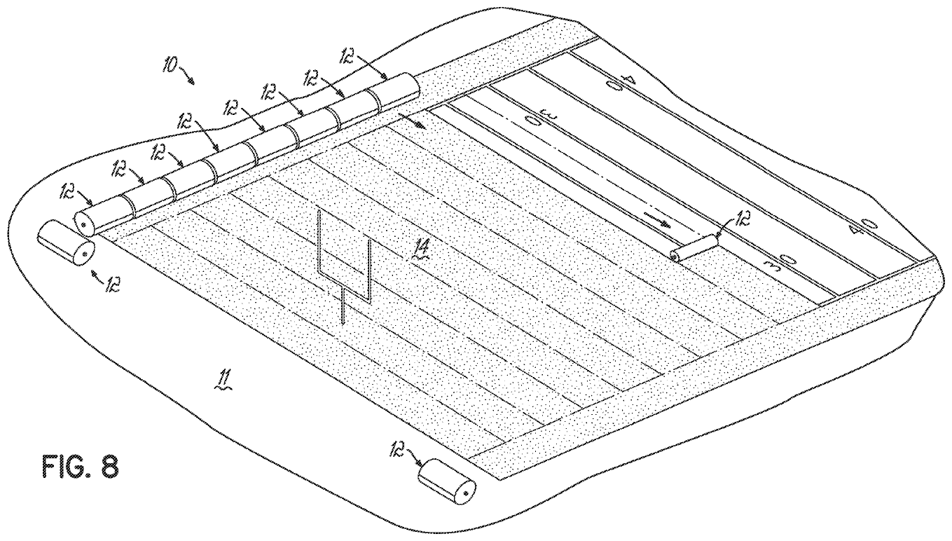

FIG. 8 illustrates a plurality of rolls 12 of filled artificial turf, each roll 12 comprising a section of filled artificial turf. Although the rolls 12 of filled artificial turf are illustrated being unrolled on a foundation 14 in a particular orientation, they may arranged and unrolled in any desired manner or configuration.

This detailed description describes one preferred embodiment of the invention. From this description, those skilled in the art will readily comprehend the general principals of the invention. Those skilled in the art will also understand the various modifications to which this invention is susceptible. For example, the backing may comprises multiple layers of material, the fibers may be of different lengths, the fill material may include particles of one or more different natural or synthetic components, the fibers may be fibulated and made of different materials such as any polyolefin, the fill depth may vary and may comprise multiple materials including gravel or sand. Therefore, applicant desires to be limited only by the scope of the following claims and equivalents thereof.

What is claimed is:

1. A method of creating an artificial turf comprising:
unrolling a plurality of already filled artificial turf sections on a foundation in a desired configuration to cover the foundation and define an athletic field, each of the sections including a backing, fibers secured to the backing and extending upwardly therefrom, and a particulate fill surrounding the fibers to a desired depth, the fibers having a construction and density so as to substantially contain the particulate fill to the backing during the unrolling;
removably connecting the sections along adjoining seams; and
adding particulate fill along the removably connected seams, thereby to create a substantially uniform fill depth for the field;
wherein the particulate fill includes at least one component selected from a group consisting of:
one or more synthetic materials; and
one or more naturally occurring components.

2. The method of claim 1 wherein the particulate fill includes one or more synthetic materials.

3. The method claim 1 wherein the particulate fill includes one or more naturally occurring materials.

4. The method of claim 1 wherein the particulate fill includes one or more naturally occurring materials and one or more synthetic materials.

5. The method of claim 1, wherein the at least one component comprises a synthetic or naturally occurring hard granular material combined with a synthetic or naturally occurring resilient material.

6. The method of claim 5, wherein the synthetic or naturally occurring hard granular material is selected from a group comprising:
silica, hard sand, granulated plastics, granulated coal slag, graded small rocks, crushed flint, crushed granite, fly ash, kaolin, alumina, mica, various silicates, talc, and boron.

7. The method of claim 5, wherein the synthetic or naturally occurring resilient material is selected from a group comprising:
cork, ground shells, fibers of almonds, coconuts, and walnuts, natural or synthetic polymer beads, beads of vinyl chloride, vinyl ether, vinyl acetate, acrylate, and methacrylate, synthetic polymer foam, styrene, neoprene, vermiculite, perlite, and natural and synthetic rubber particles, including rubber particles recycled from scrap tire, and particles of ethylene propylene diene monomer (EPDM) rubber.
